(19) United States
(12) Patent Application Publication
(10) Pub. No.: US 2025/0075530 A1
(43) Pub. Date: Mar. 6, 2025

(54) LOCK APPARATUS AND IMAGE FORMING APPARATUS

(71) Applicant: CANON KABUSHIKI KAISHA, Tokyo (JP)

(72) Inventors: KOHEI SHIMOSAWA, Kanagawa (JP); SHINYA KITAGO, Chiba (JP)

(21) Appl. No.: 18/796,862

(22) Filed: Aug. 7, 2024

(30) Foreign Application Priority Data
Aug. 28, 2023 (JP) 2023-138089

(51) Int. Cl. E05B 47/00; B41J 11/00; B41J 29/13; E05B 65/00; E05C 3/00; E05C 3/30

(52) U.S. Cl. CPC E05B 47/0004; B41J 11/006; B41J 29/13; E05B 65/00; E05C 3/006; E05C 3/30; E05B 2047/0016

(57) ABSTRACT

A lock apparatus includes: a housing; an opening and closing door that is rotatable about a support shaft of the housing; an engaging member that is movable and provided on one of the housing and the door; an engaged member provided on the other of the housing and the door; an operation member that is movable and provided on the door; and a lock mechanism configured to restrict a movement of the engaging member. When the door is closed, the engaging member is engaged with the engaged member into an engaged state. In the engaged state, when the engaging member is moved in conjunction with a movement of the operation member, the engaged state is released to allow the door to be opened. In the engaged state, when the lock mechanism restricts the movement of the engaging member, the movement of the operation member is restricted.

### BACKGROUND OF THE DISCLOSURE

### Field of the Disclosure

The present disclosure relates to a lock apparatus and an image forming apparatus.

### Description of the Related Art

An image forming apparatus is provided with a door that can be opened and closed because it is required to access an inside of the apparatus, for example, when a sheet jam occurs during sheet conveyance, or when an internal unit is periodically replaced. An engaging member is provided on a door side, and an engaged member is provided on an apparatus main body side so as to be opposed to the engaging member. When the door is closed, the engaging member and the engaged member are engaged with each other to keep the door closed. When the door is to be opened, the engaged state is released by a user's operating from the outside of the door, to thereby allow the door to be opened.

Meanwhile, from the viewpoint of safety, a mechanism that prevents printing from starting in a state in which the door is opened is installed in the image forming apparatus. For example, when the door is unintentionally opened by a user during printing, the image forming apparatus stops, and a sheet remains in a conveyance path. Particularly in a model with high printing speed, the conveyance path is increased in size, and it takes a significant amount of time to get rid of the sheets that remain in the conveyance path. This directly leads to decrease in productivity.

In response to this situation, in Japanese Patent Application Laid-Open No. 2008-229988, there is proposed a configuration in which, in a door closed state in which a door rotatably supported by an apparatus main body is engaged with the apparatus main body through use of a latch mechanism, a link mechanism is fixed by exciting a solenoid provided on a link member of the latch mechanism. With this configuration, even when door opening operation is unintentionally performed, the latch mechanism is locked, and hence the engaged state is not released, thereby being capable of preventing stop of operation of the apparatus.

However, in the door lock configuration of Japanese Patent Application Laid-Open No. 2008-229988, movement of the latch mechanism is fixed inside the apparatus, and hence there is a problem in that it is difficult for a user to notice from the outside. This is due to the fact that, for a user, a sensation of opening the door in the locked state is close to a sensation of opening the door in a normal state. That is, in this configuration, when the locked state is not recognized by a user, an excessive force may be applied to the door and the apparatus main body, which may cause damage to the apparatus.

Thus, in Japanese Patent Application Laid-Open No. 2018-76138, there is disclosed the following feeding tray which allows a user to easily recognize the locked state. The feeding tray of Japanese Patent Application Laid-Open No. 2018-76138 is provided in a main body so as to allow the feeding tray to be pulled out from the main body. The feeding tray includes a link mechanism configured to release an engaged state between the main body and the feeding tray in conjunction with rotating movement of a handle member of the feeding tray, and a hook member for locking pulling-out movement of the feeding tray. The hook member serving as a lock mechanism is rotatably provided in a position adjacent to the handle member. In this configuration, through rotating the hook member, the hook member is caught at a predetermined position of the handle member, and rotating of the handle member is fixed. As a result, in addition to locking the pulling-out movement of the feeding tray, the handle member to be operated by a user is locked, thereby being capable of improving user recognition of the fact that the pulling-out movement of the feeding tray is locked.

In the conventional door lock configuration, the lock mechanism is provided in a position close to the movable handle member provided on the door side, thereby fixing the handle member alone to be operated by a user and improving recognition. In the lock mechanism in this configuration, a restricting member is arranged on a movement locus of the handle member, and a user himself/herself switches a position of the restricting member between a locked position in which the restricting member is on the movement locus, and an unlocked position in which the restricting member is retracted from the movement locus. From the viewpoint of space saving, it is desired that a movement amount of the restricting member be small, and the small-sized lock mechanism is arranged near the handle member.

Here, in an image forming apparatus of a high-end model, a locking operation is not manually performed by a user himself/herself, but the locking operation is automatically performed by a driver inside the apparatus, so that the workability is improved, and the commodity value is improved. Accordingly, in addition to the lock mechanism in the conventional configuration, it is required to provide the driver for the restricting member. In a case in which the lock mechanism and the driver are arranged in a position close to the handle member provided on the door, an electrical connection line for supplying power to the driver is laid in the movable door, and hence there is a risk in that the electrical connection line is caught by the door and disconnected due to opening and closing operation of the door. Alternatively, providing the lock mechanism and the driver on the main body side can prevent the disconnection of the electrical connection line, but locations of the lock mechanism and the driver are limited to vicinities of the handle member, which reduces a degree of freedom in design. In addition, the handle member of the door is often located on an extension of an area where a user works when the door is opened. When the lock mechanism is arranged in the work area, decrease in jam handling and maintainability is caused. Accordingly, a door lock mechanism that is highly user-recognizable and satisfies both safety and availability has not been established.

### SUMMARY OF THE DISCLOSURE

According to an aspect of the present disclosure, a lock apparatus includes: a housing; an opening and closing door that rotates about a support shaft of the housing; an engaging member that is movable and provided on one of the housing and the opening and closing door; an engaged member provided on the other of the housing and the opening and closing door; an operation member that is movable and provided on the opening and closing door; and a lock mechanism configured to restrict a movement of the engaging member, wherein when the opening and closing door is closed, the engaging member is engaged with the engaged member to be brought into an engaged state, wherein in the engaged state between the engaging member and the engaged member, when the engaging member is moved in conjunction with a movement of the operation member, the engaged state is released to allow the opening and closing door to be opened, and wherein in the engaged state between the engaging member and the engaged member, when the lock mechanism restricts the movement of the engaging member, the movement of the operation member is restricted.

According to another aspect of the present disclosure, an image forming apparatus includes: a housing; an image forming portion provided inside the housing and configured to form an image on a recording medium; an opening and closing door that is rotatable about a support shaft of the housing; an engaging member that is movable and provided on one of the housing and the opening and closing door; an engaged member provided on the other of the housing and the opening and closing door; an operation member that is movable and provided on the opening and closing door; and a lock mechanism configured to restrict a movement of the engaging member, wherein when the opening and closing door is closed, the engaging member is engaged with the engaged member to be brought into an engaged state, wherein in the engaged state between the engaging member and the engaged member, when the engaging member is moved in conjunction with a movement of the operation member, the engaged state is released to allow the opening and closing door to be opened, and wherein in the engaged state between the engaging member and the engaged member, when the lock mechanism restricts the movement of the engaging member, the movement of the operation member is restricted.

Further features of the present disclosure will become apparent from the following description of exemplary embodiments with reference to the attached drawings.

### BRIEF DESCRIPTION OF THE DRAWINGS

FIG. 1 is a sectional view of an image forming apparatus.

FIG. 2 is a perspective view of a print module.

FIG. 3 is a perspective view of a back side of a front door.

FIG. 4A, FIG. 4B, FIG. 4C, FIG. 4D, and FIG. 4E are schematic explanatory views for illustrating an engaging operation process between a hook member and a latch shaft.

FIG. 5A and FIG. 5B are enlarged top views of a latch lock unit.

FIG. 6A and FIG. 6B are left side views of the latch lock unit.

FIG. 7A, FIG. 7B, and FIG. 7C are schematic views of a latch lock unit in a second embodiment.

FIG. 8 is a perspective view of a print module in a third embodiment.

FIG. 9 is an enlarged view of parts related to an operation unit for the front door.

### DESCRIPTION OF THE EMBODIMENTS

Hereinafter, the embodiments of the present disclosure will be described with reference to the accompanying drawings. However, the present disclosure is not limited to the following embodiments.

### First Embodiment

### [Image Forming Apparatus]

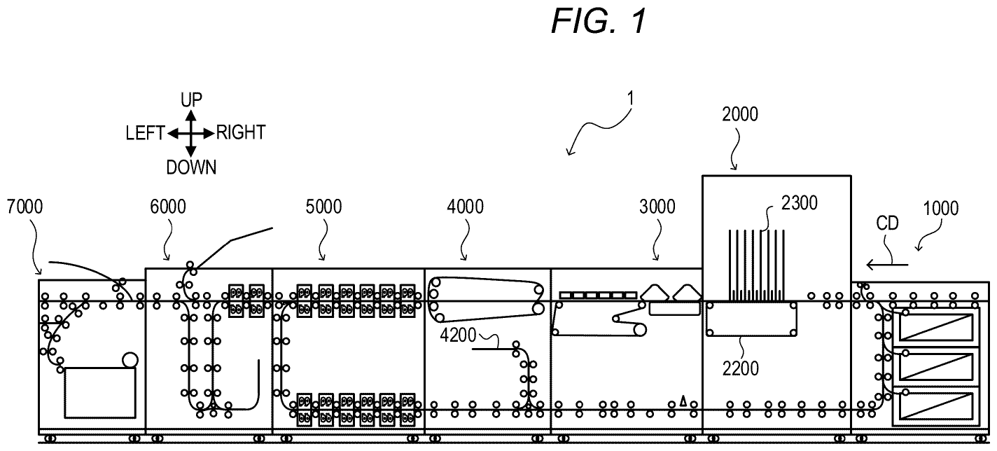

Now, an image forming apparatus 1 according to the embodiment is described with reference to the drawings. FIG. 1 is a sectional view of the image forming apparatus 1. The image forming apparatus 1 is a sheet-fed inkjet recording apparatus that forms an ink image (image) on a sheet serving as a recording medium using two liquids, that is, a reaction liquid and ink. However, the image forming apparatus 1 is not limited to this, and may be, for example, an electrophotographic image forming apparatus that forms a toner image on a sheet. FIG. 1 is a sectional front view of the image forming apparatus 1 seen from a front side of the image forming apparatus 1 toward a back side thereof. The terms “up”, “down”, “right”, and “left” as used in the present disclosure are defined in directions indicated by the arrows in FIG. 1.

The image forming apparatus 1 includes a feeding module (sheet conveying apparatus) 1000, a print module 2000, a drying module 3000, a fixing module 4000, a cooling module 5000, a reversing module 6000, and a discharge stacking module 7000. A sheet to be fed from the feeding module 1000 is conveyed along a conveyance path, processed in each module, and discharged to the discharge stacking module 7000. [Print Module]

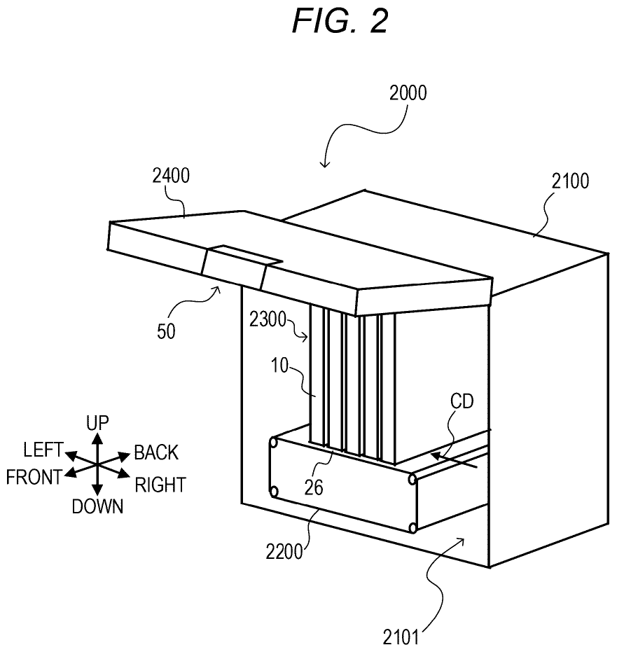

With reference to FIG. 2, a configuration of the print module 2000 is described. FIG. 2 is a perspective view of the print module 2000. The print module 2000 performs, by a recording head 10 from above, recording processing on a sheet to be conveyed, to thereby form an image on the sheet. The print module 2000 includes a box-shaped housing (apparatus main body) 2100 provided with an opening portion 2101 through which a user can access the interior thereof. The housing 2100 includes a front door (rotating door) 2400 that is rotatably provided as an opening and closing door (opening and closing member) capable of opening and closing the opening portion 2101.

Inside the housing 2100, a before-image-formation registration correction portion, a print belt unit 2200, and a recording portion (image forming portion) 2300 are accommodated.

A sheet conveyed from the feeding module 1000 is conveyed to the print belt unit 2200 after an inclination and a position of the sheet are corrected by the before-image-formation registration correction portion. The recording portion 2300 is arranged across the conveyance path so as to be opposed to the print belt unit 2200. The recording portion 2300 is an image forming portion that forms an image on a sheet by performing recording processing (printing) on the sheet by the recording head 10 from above the sheet to be conveyed in a conveying direction CD. The print belt unit 2200 is arranged below the recording portion 2300. The print belt unit 2200 attracts and conveys a sheet so that a behavior of the sheet to be conveyed directly under the recording head 10 is stable. As a result, the sheet to be conveyed on an image forming plane 26 directly under the recording head 10 is conveyed with a clearance between the sheet and the recording head 10 being secured.

A plurality of recording heads 10 are aligned along the conveying direction CD. Each of the plurality of recording heads 10 discharges ink with intended discharge timing to the sheet being conveyed, to thereby form an image. In the embodiment, the plurality of recording heads 10 include a total of five line-type recording heads corresponding to a reaction liquid as well as four colors, Y (yellow), M (magenta), C (cyan), and Bk (black). The number of colors and the number of recording heads are not limited to five. As the inkjet system, for example, a system using a heating element, a system using a piezo element, a system using an electrostatic element, or a system using a micro electro mechanical system (MEMS) element can be adapted. When a sheet being conveyed becomes stuck in the conveyance path due to a sheet jam, a user can access the interior of the print module 2000 by opening the front door 2400 as illustrated in FIG. 2, and can remove the stuck sheet.

### (Configuration of Front Door)

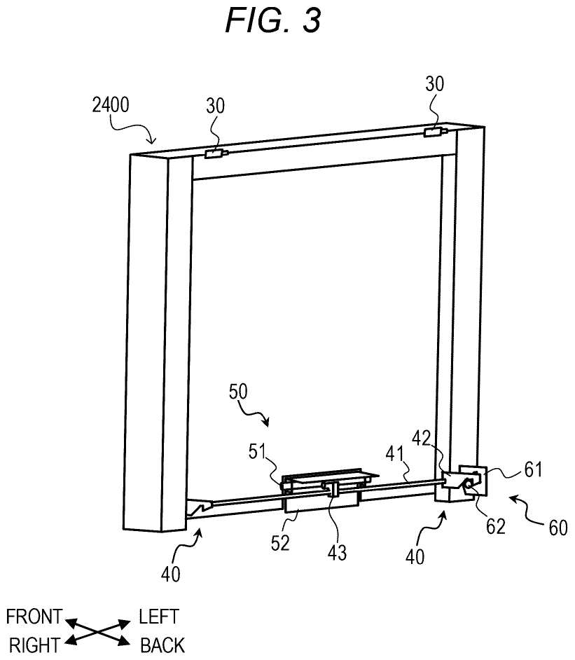

In the following, with reference to FIG. 3, a configuration of the front door 2400 in the image forming apparatus 1 according to the embodiment is described. FIG. 3 is a perspective view of the back side of the front door 2400. A plurality of hinges (support shafts) 30 are fixed to an upper portion of the housing 2100 and an upper portion of the front door 2400. The front door 2400 is supported by the plurality of hinges 30 so as to be rotatable with respect to the housing 2100. A user can access the interior of the print module 2000 by opening the front door 2400. By lifting the front door 2400 upward about the hinges 30, the front door 2400 is brought into an open state as illustrated in FIG. 2.

At a lower portion of the front door 2400, there is provided a latch unit 40 serving as an engaging mechanism including hook members 42 serving as movable (rotatable) engaging members. At a lower portion of the housing 2100, there is provided latch shaft units 60 each including a latch shaft supporting plate (support member) 61 and a latch shaft 62 serving as an engaged member provided on the latch shaft supporting plate 61. In FIG. 3, only the latch shaft unit 60 on the left side is illustrated. When the front door 2400 is closed, the hook members 42 are engaged with the latch shafts 62 to keep the front door closed, and the front door 2400 does not open due to minor disturbances such as vibration.

In the embodiment, each of the hook members 42 serving as an engaging member is provided on the front door 2400, and each of the latch shafts 62 serving as an engaged member is provided on the housing 2100. However, the embodiment is not limited to this, and each of the hook members 42 serving as the engaging member may be provided on the housing 2100, and each of the latch shafts 62 serving as the engaged member may be provided on the front door 2400. That is, it is only required that the hook member 42 be provided on one of the housing 2100 and the front door 2400, and the latch shaft 62 be provided on the other of the housing 2100 and the front door 2400. Further, the latch shaft 62 may be configured as a movable engaging member, and the hook member 42 may be configured as a stationary engaged member.

The latch unit 40 includes a latch rotary shaft 41 and the hook members 42. The latch rotary shaft 41 is supported rotatably with respect to the front door 2400. The hook members 42 are fixed to both end portions of the latch rotary shaft 41 in positions in which the hook members 42 are accommodated inside the front door 2400. In a state in which the front door 2400 is closed, when the latch rotary shaft 41 is rotated by an external force applied to the latch rotary shaft 41, the hook members 42 are rotated integrally with the latch rotary shaft 41 to switch a state from an engaged state between the hook members 42 and the latch shafts 62 to a disengaged state. In a case in which the latch unit 40 serving as an engaging mechanism is provided at each of both end portions of the front door 2400, when a force is applied to open the front door 2400 in the engaged state between the hook members 42 and the latch shafts 62, the force is distributed to both end portions of the front door 2400. Thus, deformation of the front door 2400 can be suppressed as compared to a case in which the engaging mechanism is provided only at one end portion of the front door 2400.

On the front side of the front door 2400, there is provided an operation unit 50 including an operation member rotary shaft 51 and a movable (rotatable) operation member (handle member) 52. The operation member rotary shaft 51 is fixed to and supported by the front door 2400. The operation member 52 can be rotated about the operation member rotary shaft 51 within a range of a predetermined angle. When the operation member 52 is rotated, the operation member 52 is brought into abutment against a transmission member 43 of the latch unit 40 in a predetermined rotation position of the operation member 52. When the operation member 52 is further rotated, the latch rotary shaft 41 is rotated along with the rotating of the operation member 52. That is, owing to the rotating of the operation member 52, the engaged state between the hook members 42 and the latch shafts 62 in a closed state of the front door 2400 is released. The operation member 52 has a handle shape for a user to grip the front door 2400. In addition to a function as an operation portion that releases the engaged state between the hook members 42 and the latch shafts 62 in the closed state of the front door 2400, the operation member 52 also has a function as a grip portion to be gripped by a user in opening and closing operation of the front door 2400. This eliminates the need to provide a separate handle-shaped portion on the front door 2400, thereby being capable of preventing increase in shape complexity of the front door 2400.

### (Opening and Closing Operation of Front Door)

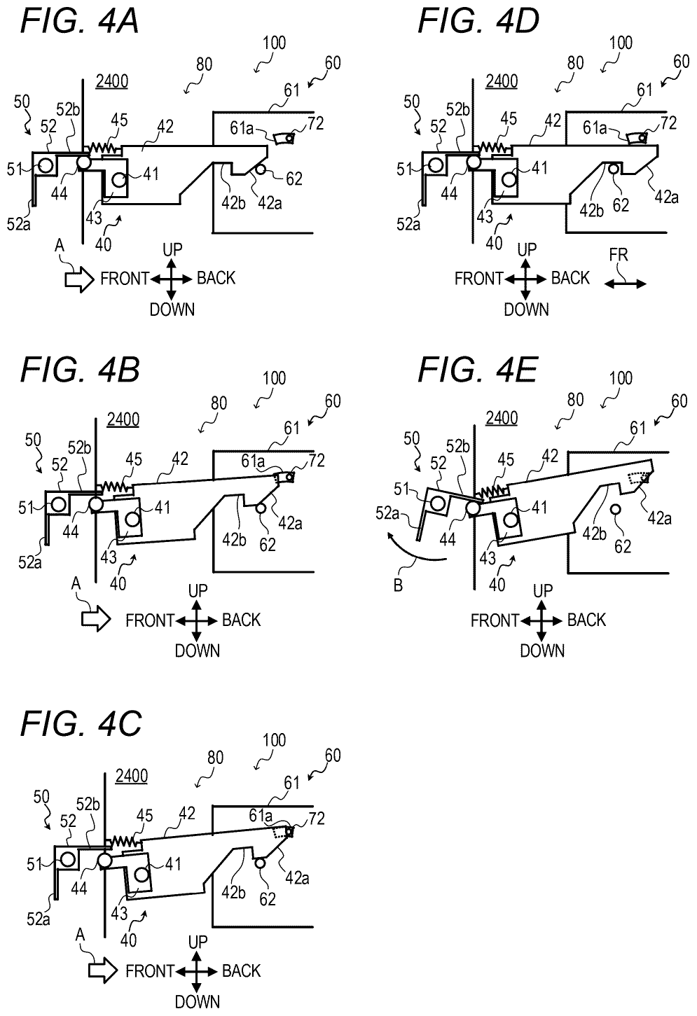

With reference to FIG. 4A, FIG. 4B, FIG. 4C, FIG. 4D, and FIG. 4E, description is given of an engaged state and a disengaged state between the hook member 42 and the latch shaft 62 in the opening and closing operation of the front door 2400. FIG. 4A, FIG. 4B, FIG. 4C, FIG. 4D, and FIG. 4E are schematic explanatory views for illustrating an engaging operation process between the hook member 42 and the latch shaft 62. A latch mechanism 80 includes the latch unit 40 and the latch shaft unit 60. The latch mechanism 80 is provided at both end portions of the print module 2000 in a right-left direction and has a symmetrical shape. FIG. 4A, FIG. 4B, FIG. 4C, FIG. 4D, and FIG. 4E are illustrations of the engaging operation process of a left part of the latch mechanism 80. FIG. 4A, FIG. 4B, FIG. 4C, and FIG. 4D are illustrations of step-by-step engaging operation of the latch mechanism 80 when the front door 2400 transitions from the open state to the closed state. FIG. 4E is an illustration of the disengaged state of the latch mechanism 80. A right part of the latch mechanism 80 also operates in the same manner as the left part of the latch mechanism 80 described above.

The latch unit 40 includes, in addition to the above-mentioned latch rotary shaft 41 and the hook members 42 provided at both end portions of the latch rotary shaft 41, a rotation member 44 and the transmission member 43 provided at a center portion of the latch rotary shaft 41 and includes restoring members 45 mounted to the hook members 42, respectively. The transmission member 43 has an L shape and is fixed to the latch rotary shaft 41 at the center portion in an axial direction of the latch rotary shaft 41. The rotation member 44 is a cylindrical member formed with a material having a high surface sliding property and is rotatably supported by the transmission member 43. The restoring member 45 is, for example, an urging member such as a compression coil spring. One end portion (spring seating surface) of the restoring member 45 is mounted to the hook member 42, and the other end portion (spring seating surface) of the restoring member 45 is mounted to the front door 2400. The restoring member 45 applies a restoring force (urging force) to the hook member 42 so that a longitudinal direction of the hook member 42 is horizontal and maintains a posture of the hook member 42.

When a user rotates the front door 2400 in the open state so as to close the front door 2400, the latch unit 40 and the operation unit 50 provided on the front door 2400 are moved from the front to the back in a closing direction A as indicated by the arrows in FIG. 4A, FIG. 4B, and FIG. 4C. As the front door 2400 is moved in the closing direction A, an inclined portion 42a of the hook member 42 first comes into abutment against the latch shaft 62 as illustrated in FIG. 4A. When the front door 2400 is further moved in the closing direction A, the hook member 42 is lifted up and starts to rotate as the inclined portion 42a is guided by the latch shaft 62 as illustrated in FIG. 4B, and the restoring member 45 is gradually compressed. In addition, when the front door 2400 is further moved in the closing direction A, the inclined portion 42a passes the latch shaft 62, and the hook member 42 climbs on the latch shaft 62 as illustrated in FIG. 4C and the restoring member 45 is further compressed, and the maximum restoring force is stored in the restoring member 45. When the front door 2400 is further moved in the closing direction A and a groove 42b of the hook member 42 reaches the latch shaft 62 as illustrated in FIG. 4D, the hook member 42 returns to its original horizontal state by the restoring force of the restoring member 45, and the latch shaft 62 is engaged with the groove 42b. In this state, even when the front door 2400 is moved in a front-back direction FR, the latch shaft 62 comes into abutment against a wall surface of the groove 42b, and hence the movement of the front door 2400 in the front-back direction FR is restricted. When the front door 2400 is brought into the closed state through the closing operation illustrated in FIG. 4A to FIG. 4D, the hook member 42 and the latch shaft 62 are engaged with each other, that is, the front door 2400 and the housing 2100 are engaged with each other.

When opening the front door 2400 in the closed state, a user performs an operation of pulling a grip portion 52a of the operation member 52 in a direction from the back to the front as indicated by the arrow B in FIG. 4E, thereby rotating the operation member 52 clockwise about the operation member rotary shaft 51. Here, the operation member 52 is covered by a frame of the front door 2400, and hence the rotating of the operation member 52 is restricted within a predetermined angle. In conjunction with the rotating of the operation member 52, an action portion 52b of the operation member 52 pushes down the rotation member 44 supported by the transmission member 43, thereby rotating the transmission member 43 counterclockwise. The latch rotary shaft 41 rotates together with the transmission member 43, and hence the hook member 42 rotates counterclockwise together with the latch rotary shaft 41 about the latch rotary shaft 41. When the hook member 42 rotates counterclockwise, the groove 42b is separated away from the latch shaft 62, and an engaged state between the front door 2400 and the housing 2100 is released, thereby being capable of opening the front door 2400 in a frontward direction. In order to reduce a frictional force generated between the operation member 52 and the transmission member 43 so that the movement of the operation member 52 can be transmitted to the transmission member 43 reliably, the movement of the operation member 52 is transmitted to the transmission member 43 via the rotation member 44. However, when the frictional force generated between the operation member 52 and the transmission member 43 can be reduced by, for example, materials and shapes of the operation member 52 and the transmission member 43, the rotation member 44 may be omitted, and the operation member 52 and the transmission member 43 may be in direct contact with each other.

### (Lock Mechanism)

In the image forming apparatus 1 according to the embodiment, by pulling the operation member 52 in the frontward direction, the engaged state between the front door 2400 and the housing 2100 is released, and the front door 2400 can be opened. However, when the operation member 52 is unintentionally operated by a user while the image forming apparatus 1 is in operation, the front door 2400 opens, and thus the image forming apparatus 1 stops. Thus, while the image forming apparatus 1 is in operation, it is desired that the front door 2400 be locked and the engaged state is not released even when the front door 2400 is unintentionally subjected to the opening operation.

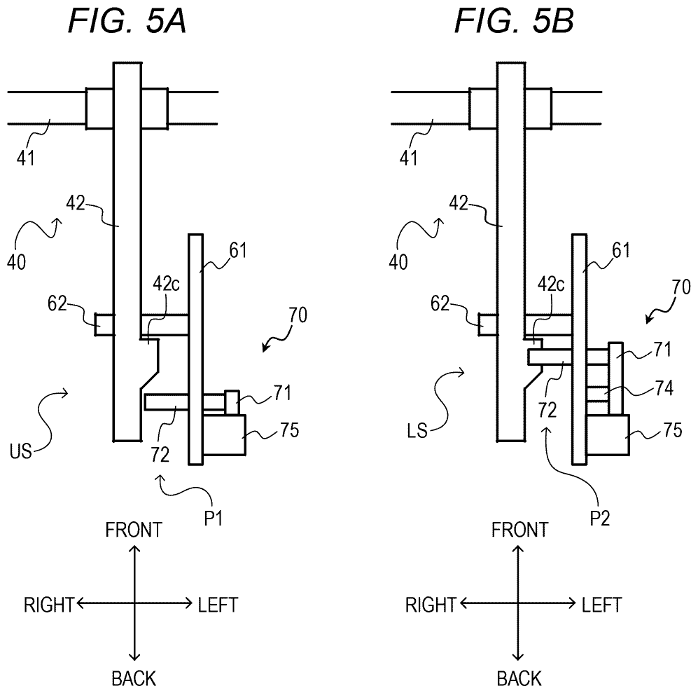

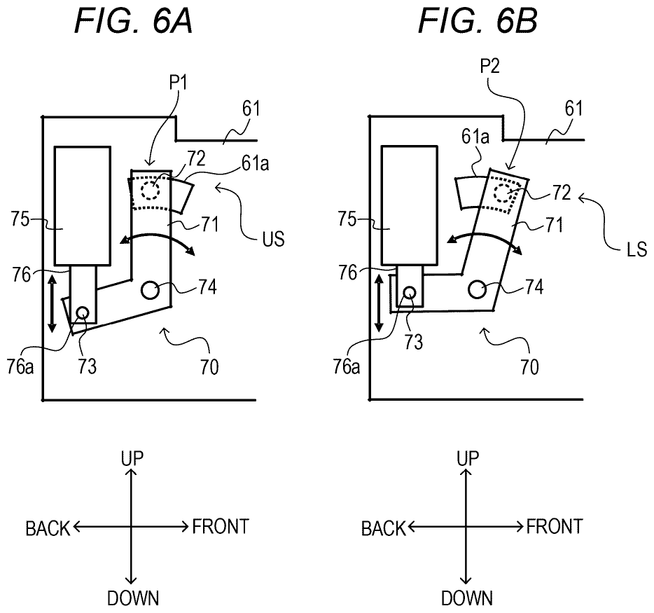

With reference to FIG. 5A, FIG. 5B, FIG. 6A, and FIG. 6B, description is given of operation of a latch lock unit 70 serving as a lock mechanism that restricts the movement of the operation member 52 and restricts opening of the front door 2400. FIG. 5A and FIG. 5B are enlarged top views of the latch lock unit 70. FIG. 6A and FIG. 6B are left side views of the latch lock unit 70. FIG. 5A, FIG. 5B, FIG. 6A, and FIG. 6B are illustrations of the front door 2400 in the closed state, that is, a state in which the hook member 42 is engaged with the latch shaft 62. FIG. 5A and FIG. 6A are illustrations of the front door 2400 in an unlocked state US, that is, a state in which the front door 2400 is not locked. FIG. 5B and FIG. 6B are illustrations of a locked state LS in which the front door 2400 is locked by the latch lock unit 70. In the first embodiment, the latch lock unit 70 is provided at both end portions of the print module 2000 in the right-left direction. A lock apparatus 100 that locks the front door 2400 to the housing 2100 includes the latch unit 40, the latch shaft unit 60, and the latch lock unit 70.

The hook member 42 includes the groove 42b that is engaged with the latch shaft 62 when the front door 2400 is closed, and a protruding portion 42c. The protruding portion 42c is formed so that a part of the hook member 42 protrudes in a direction from the inside (left side of FIG. 5A) to the outside (right side of FIG. 5A) of the housing 2100. The latch lock unit 70 includes a link mechanism configured to restrict the movement of the latch unit 40. The latch lock unit 70 includes a lock link (link member) 71, a lock member 72, a link coupling shaft 73, a lock link rotary shaft 74 being a center of rotation of the lock link 71, and a solenoid 75 serving as a driver.

The lock member 72 and the link coupling shaft 73 are shaft-shaped components (shaft members), and are fixedly joined to the lock link 71 by caulking or the like. The lock link rotary shaft 74 is fixedly joined to the latch shaft supporting plate 61 and rotatably supports the lock link 71 to which the lock member 72 and the link coupling shaft 73 are fixedly joined. The lock member 72 extends through a through window 61a formed in the latch shaft supporting plate 61, and protrudes toward the inside of the housing 2100, that is, toward a side on which the hook member 42 is arranged. The solenoid 75 is removably fixed to one of both side surfaces of the latch shaft supporting plate 61 that faces the outside of the housing 2100. The fact that the solenoid 75 is provided not on the side of the front door 2400 but on the side of the housing 2100 eliminates the need for electrical connection lines such as a power line and a communication line connected with the solenoid 75 to be laid on the side of the front door 2400. Thus, disconnection of the electrical connection lines can be prevented. A hole 76a is formed in a distal end portion of a plunger 76 of the solenoid 75. The link coupling shaft 73 of the lock link 71 is rotatably fitted into the hole 76a of the plunger 76. A linear motion of the solenoid 75 is converted into a rotational motion of the lock link 71 via the link coupling shaft 73.

As illustrated in FIG. 5A, in the unlocked state US, the lock member 72 is located on the back side of the housing 2100, and has a non-contact positional relationship with the protruding portion 42c of the hook member 42 that is located more on the front side. The lock member 72 is in a first position P1 outside a movement locus of the protruding portion 42c of the hook member 42. In the unlocked state US, the plunger 76 of the solenoid 75 is in a pulled-out position as illustrated in FIG. 6A. In the unlocked state US, the lock member 72 is in a position in which the lock member 72 does not collide with the protruding portion 42c of the hook member 42 when the hook member 42 is lifted. When a user pulls the grip portion 52a of the operation member 52 forward as illustrated in FIG. 4E, the hook member 42 is lifted upward without the lock member 72 colliding with the protruding portion 42c, and the engaged state between the hook member 42 and the latch shaft 62 is released. Then, the user can lift up the grip portion 52a to open the front door 2400.

Meanwhile, in the locked state LS, the plunger 76 of the solenoid 75 is in a retracted position as illustrated in FIG. 6B. The lock link 71 rotates about the lock link rotary shaft 74 to the front side of the housing 2100, and the lock member 72 is moved to the front side of the housing 2100. As illustrated in FIG. 5B, in the locked state LS, the lock member 72 is in a second position P2 within the movement locus of the protruding portion 42c of the hook member 42 so that the lock member 72 collides with the protruding portion 42c of the hook member 42 when the hook member 42 is lifted. The lock member 72 is located so as to overlap the protruding portion 42c when seen from above. Even when the grip portion 52a of the operation member 52 is pulled forward and the hook member 42 is rotated so as to be lifted upward, the hook member 42 is not rotated beyond a clearance between the lock member 72 and the protruding portion 42c because the protruding portion 42c comes into abutment against the lock member 72. At this time, the operation member 52, which rotates in conjunction with the hook member 42, also does not rotate more than the same amount as the hook member 42 that is locked. That is, the operation member 52 is fixed together with the hook member 42 in the locked state LS, and hence the user can easily recognize that the front door 2400 is in the locked state LS when the user unintentionally operates the grip portion 52a, thereby being capable of preventing an excessive force from being applied to the front door 2400.

The hook member 42 is not always required to be provided with the protruding portion 42c. In such a case, it is only required that the lock member 72 be configured to be movable between a position (first position) outside a movement locus of the hook member 42 and a position (second position) within the movement locus of the hook member 42.

In the first embodiment, the latch shaft 62, which is engaged with the hook member 42, and the lock link rotary shaft 74, which is the center of rotation of the lock member 72, are both joined and fixed to the latch shaft supporting plate 61. This is to increase positional accuracy between the protruding portion 42c of the hook member 42 and the lock member 72, which allows the lock member 72 to reliably lock the hook member 42. Particularly in a case that the image forming apparatus 1 has a large size, the front door 2400 becomes larger in accordance with dimensions of a main body of the image forming apparatus 1 and is easily deformed due to deflection or other reasons. When the front door 2400 is deformed, the hook member 42 is shifted from an ideal position, and hence it is assumed that the protruding portion 42c and the lock member 72 are not brought into contact with each other when the hook member 42 is rotated in the locked state LS of the lock member 72. In contrast, owing to the latch lock unit 70 in the first embodiment, the front door 2400 can be reliably locked even for the image forming apparatus 1 having the large size.

According to the first embodiment, a user can be prevented from applying an excessive force to the front door 2400 as compared to the conventional door lock configurations. In addition, the user can easily recognize the engaged state (locked state) of the front door 2400 while maintaining the user's work area.

### Second Embodiment

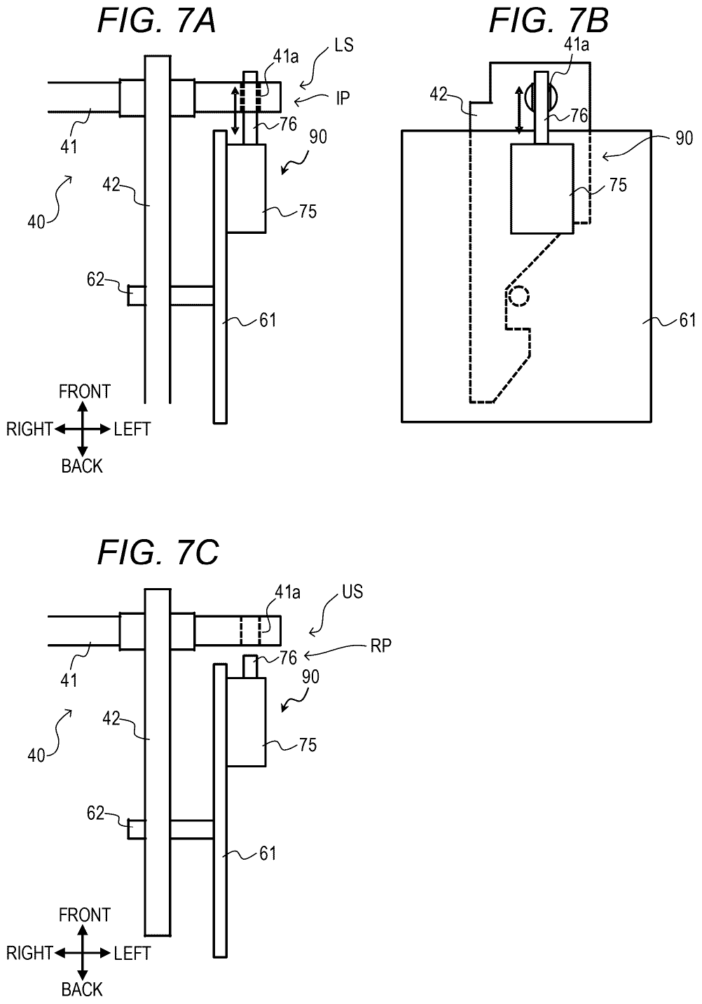

In the following, a second embodiment is described. In the second embodiment, the structure similar to that in the first embodiment is denoted by the same reference symbol, and description thereof is omitted. The image forming apparatus 1 and the print module 2000 in the second embodiment are the same as those in the first embodiment, and hence description thereof is omitted. FIG. 7A, FIG. 7B, and FIG. 7C are schematic views of a latch lock unit 90 in the second embodiment. FIG. 7A is a top view of the latch lock unit 90 in the locked state LS. FIG. 7B is a left side view of the latch lock unit 90. FIG. 7C is a top view of the latch lock unit 90 in the unlocked state US. With reference to FIG. 7A, FIG. 7B, and FIG. 7C, the latch lock unit 90 in the second embodiment is described. In the second embodiment, the latch lock unit 90 is provided at each of both end portions of the print module 2000 in the right-left direction.

The latch lock unit 90 in the second embodiment can restrict the rotation of the latch rotary shaft 41 and fix the latch unit 40 and the operation member 52. The latch lock unit 90 is formed only of the solenoid 75 serving as a driver, and the plunger 76 of the solenoid 75 functions as a lock member. Instead of using the plunger 76 of the solenoid 75 serving as a lock member, a separate component serving as a lock member may be provided on the plunger 76. A slot portion 41a extending in a normal direction of the latch rotary shaft 41 is formed in an end portion of the latch rotary shaft 41. The slot portion 41a has a width wider than a width of the plunger 76. The plunger 76 can enter and exit the slot portion 41a.

As illustrated in FIG. 7C, in the unlocked state US of the latch unit 40, the plunger 76 of the solenoid 75 is in a retracted position RP in which the plunger 76 is retracted and out of the slot portion 41a and is separated away from the latch rotary shaft 41. As illustrated in FIG. 7A, in the locked state LS of the latch unit 40, the plunger 76 of the solenoid 75 is pulled out and is in an entry position IP in which the plunger 76 enters the slot portion 41a of the latch rotary shaft 41 on an extension and retraction locus of the plunger 76. The plunger 76 serving as the lock member restricts the rotational motion of the latch rotary shaft 41, and thus the latch rotary shaft 41 and the operation member 52 are fixed. According to the second embodiment, the latch lock unit 90 serving as the lock mechanism for the front door 2400 can be formed of a small number of components, thereby being capable of saving space and cost.

In the second embodiment, the hook member 42 serving as the engaging member is provided on the front door 2400, and the latch shaft 62 serving as the engaged member is provided on the housing 2100. However, the hook member 42 may be provided on one of the housing 2100 and the front door 2400, and the latch shaft 62 may be provided on the other of the housing 2100 and the front door 2400.

According to the second embodiment, a user can be prevented from applying an excessive force to the front door 2400 as compared to the conventional door lock configurations. In addition, the user can easily recognize the engaged state (locked state) of the front door 2400 while maintaining the user's work area.

### Third Embodiment

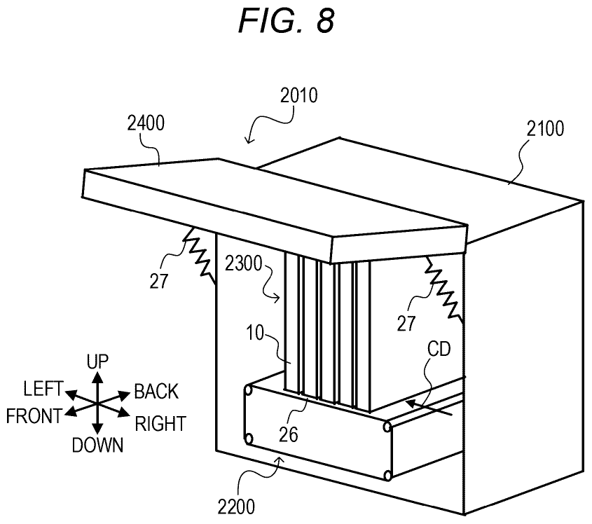

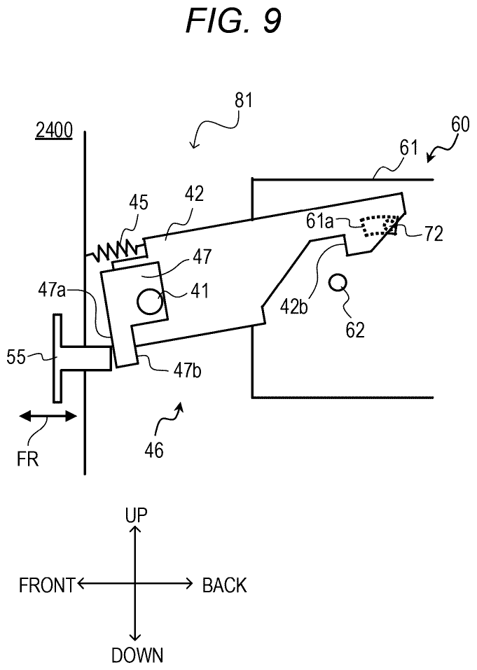

In the following, a third embodiment is described. In the third embodiment, the structure similar to that in the first embodiment is denoted by the same reference symbol, and description thereof is omitted. The image forming apparatus 1 according to the third embodiment is the same as that according to the first embodiment, and hence description thereof is omitted. Further, the latch lock unit 70 serving as the lock mechanism in the third embodiment is the same as that in the first embodiment, and hence description thereof is omitted. FIG. 8 is a perspective view of a print module 2010 in the third embodiment. FIG. 9 is a schematic view of a latch mechanism 81 in the third embodiment. With reference to FIG. 8 and FIG. 9, a configuration of the front door 2400 in the third embodiment is described.

A compression coil spring 27 serving as an opening assist member is provided on each of right and left side portions of the housing (apparatus main body) 2100 of the print module 2010 in the third embodiment. The opening assist member is not limited to the compression coil spring 27, and may be an elastic member such as rubber or an electric driver. One end portion of each compression coil spring 27 is fixed to the front door 2400, and the other end portion thereof is fixed to the housing 2100. The compression coil spring 27 provides the front door 2400 with an assisting force of opening the front door 2400, and hence the front door 2400 can be opened by a restoring force of the compression coil spring 27 without a user lifting up the front door 2400 by himself/herself. When closing the front door 2400, the compression coil spring 27 is compressed to store the restoring force. When the engaged state between the front door 2400 and the housing 2100 is released to open the front door 2400, the restoring force of the compression coil spring 27 is released, and the compression coil spring 27 provides the front door 2400 with a force of assisting the opening operation of the front door 2400.

The latch unit 46 serving as an engaging mechanism in the third embodiment includes the latch rotary shaft 41, the hook members 42 respectively provided at both end portions of the latch rotary shaft 41, a transmission member 47 provided at the center portion of the latch rotary shaft 41, and the restoring members 45. The transmission member 47 includes an extended portion 47b extending below the latch rotary shaft 41 to form a contact surface 47a extending in an up-down direction. An operation member 55 in the third embodiment is provided on the front door 2400 so as to be linearly movable in the front-back direction FR. When the operation member 55 is moved from the front side toward the back side in the closed state of the front door 2400, the operation member 55 comes into contact with the contact surface 47a of the transmission member 47 and pushes the extended portion 47b of the transmission member 47 from the front side to the back side. The linear motion of the operation member 55 from the front side to the back side is converted into a counterclockwise rotational motion of the transmission member 47 in FIG. 9, and the latch rotary shaft 41 rotates counterclockwise together with the transmission member 47. As a result, the hook member 42 is rotated upward, and the groove 42b of the hook member 42 is separated away from the latch shaft 62 so that the engaged state between the front door 2400 and the housing 2100 is released, and the front door 2400 is opened in the forward direction by the compression coil springs 27. That is, in the third embodiment, the front door 2400 can be opened automatically only by a user pressing the operation member 55 from the outside, which improves usability.

In the third embodiment, the latch unit 46 serving as an engaging mechanism including the hook member 42 serving as an engaging member is provided on the front door 2400, and the latch shaft unit 60 including the latch shaft 62 serving as an engaged member is provided on the housing 2100. However, the latch unit 46 may be provided on the housing 2100, and the latch shaft unit 60 may be provided on the front door 2400. That is, the hook member 42 may be provided on one of the housing 2100 and the front door 2400, and the latch shaft 62 may be provided on the other of the housing 2100 and the front door 2400.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-138089, filed Aug. 28, 2023, which is hereby incorporated by reference herein in its entirety.

What is claimed is:

1. A lock apparatus comprising:
a housing;
an opening and closing door that is rotatable about a support shaft of the housing;
an engaging member that is movable and provided on one of the housing and the opening and closing door;
an engaged member provided on the other of the housing and the opening and closing door;
an operation member that is movable and provided on the opening and closing door; and
a lock mechanism configured to restrict a movement of the engaging member,
wherein when the opening and closing door is closed, the engaging member is engaged with the engaged member to be brought into an engaged state,
wherein in the engaged state between the engaging member and the engaged member, when the engaging member is moved in conjunction with a movement of the operation member, the engaged state is released to allow the opening and closing door to be opened, and
wherein in the engaged state between the engaging member and the engaged member, when the lock mechanism restricts the movement of the engaging member, the movement of the operation member is restricted.

2. The lock apparatus according to claim 1,
wherein the lock mechanism includes:
a movable lock member; and
a driver configured to move the lock member,
wherein the lock member is movable between a first position outside a movement locus of the engaging member and a second position within the movement locus, and
wherein when the lock member is in the second position, the movement of the engaging member and the movement of the operation member are restricted.

3. The lock apparatus according to claim 1, further comprising a rotary shaft that rotatably supports the engaging member,
wherein the lock mechanism includes:
a movable lock member; and
a driver configured to move the lock member,
wherein a slot portion is provided in the rotary shaft,
wherein the lock member is movable between an entry position in which the lock member enters the slot portion and a retracted position in which the lock member is retracted from the slot portion, and
wherein when the lock member is in the entry position, the movement of the engaging member and the movement of the operation member are restricted.

4. The lock apparatus according to claim 1, wherein the engaging member and the engaged member are provided in each position of both end portions of the opening and closing door in a direction of the support shaft.

5. The lock apparatus according to claim 1, wherein the operation member is a grip portion to be gripped by a user when opening and closing the opening and closing door.

6. The lock apparatus according to claim 1, further comprising an opening assist member configured to assist an opening operation of the opening and closing door,
wherein when the movement of the operation member is not restricted, the operation member is pushed by a user and thus moves linearly to release the engaged state between the engaging member and the engaged member, the opening and closing door is opened by the opening assist member.

7. The lock apparatus according to claim 1, further comprising an urging member configured to urge the engaging member to maintain the engaged state between the engaging member and the engaged member.

8. The lock apparatus according to claim 1, further comprising:
a rotary shaft that rotatably supports the engaging member; and
a transmission member provided on the rotary shaft,
wherein when the transmission member is rotated by the movement of the operation member, the rotary shaft and the engaging member are rotated integrally with the transmission member to release the engaged state.

9. An image forming apparatus comprising:
a housing;
an image forming portion provided inside the housing and configured to form an image on a recording medium;
an opening and closing door that is rotatable about a support shaft of the housing;
an engaging member that is movable and provided on one of the housing and the opening and closing door;
an engaged member provided on the other of the housing and the opening and closing door;
an operation member that is movable and provided on the opening and closing door; and
a lock mechanism configured to restrict a movement of the engaging member,
wherein when the opening and closing door is closed, the engaging member is engaged with the engaged member to be brought into an engaged state,
wherein in the engaged state between the engaging member and the engaged member, when the engaging member is moved in conjunction with a movement of the operation member, the engaged state is released to allow the opening and closing door to be opened, and
wherein in the engaged state between the engaging member and the engaged member, when the lock mechanism restricts the movement of the engaging member, the movement of the operation member is restricted.

10. The image forming apparatus according to claim 9,
wherein the lock mechanism includes:
a movable lock member; and
a driver configured to move the lock member,
wherein the lock member is movable between a first position outside a movement locus of the engaging member and a second position within the movement locus, and
wherein when the lock member is in the second position, the movement of the engaging member and the movement of the operation member are restricted.

11. The image forming apparatus according to claim 10, further comprising:
a link member to which the lock member is fixed;
a rotary shaft that rotatably supports the link member; and
a support member that supports the engaged member and the rotary shaft.

12. The image forming apparatus according to claim 10, wherein the driver is provided to the housing.

13. The image forming apparatus according to claim 10, wherein the driver is a solenoid.

14. The image forming apparatus according to claim 9, further comprising a rotary shaft that rotatably supports the engaging member,
wherein the lock mechanism includes:
a movable lock member; and
a driver configured to move the lock member,
wherein a slot portion is provided in the rotary shaft,
wherein the lock member is movable between an entry position in which the lock member enters the slot portion and a retracted position in which the lock member is retracted from the slot portion, and
wherein when the lock member is in the entry position, the movement of the engaging member and the movement of the operation member are restricted.

15. The image forming apparatus according to claim 14,
wherein the driver is a solenoid, and
wherein the lock member is a plunger of the solenoid.

16. The image forming apparatus according to claim 9, wherein the engaging member and the engaged member are provided in each position of both end portions of the opening and closing door in a direction of the support shaft.

17. The image forming apparatus according to claim 9, wherein the operation member is a grip portion to be gripped by a user when opening and closing the opening and closing door.

18. The image forming apparatus according to claim 9, further comprising an opening assist member configured to assist an opening operation of the opening and closing door,
wherein when the movement of the operation member is not restricted, the operation member is pushed by a user and thus moves linearly to release the engaged state between the engaging member and the engaged member, the opening and closing door is opened by the opening assist member.

19. The image forming apparatus according to claim 9, further comprising an urging member configured to urge the engaging member to maintain the engaged state between the engaging member and the engaged member.

20. The image forming apparatus according to claim 9, further comprising:
a rotary shaft that rotatably supports the engaging member; and
a transmission member provided on the rotary shaft,
wherein when the transmission member is rotated by the movement of the operation member, the rotary shaft and the engaging member are rotated integrally with the transmission member to release the engaged state.
